(19) United States
(12) Patent Application Publication
(10) Pub. No.: US 2008/0128615 A1
(43) Pub. Date: Jun. 5, 2008

(54) Real time analyzer and method for analysis

(75) Inventors: Masuyoshi Yamada, Ichikawa (JP); Masako Ishimaru, Tokyo (JP)

Correspondence Address: Stanley P. Fisher;Reed Smith LLP, 3110 Fairview Park Drive, Suite 1400, Falls Church, VA, 22042-4503, US

(73) Assignee: Hitachi, Ltd.

(21) Appl. No.: 11/987,085

(22) Filed: Nov. 27, 2007

(30) Foreign Application Priority Data
Dec. 1, 2006 (JP) 2006-325130

(51) Int. Cl. H01J 49/04

(52) U.S. Cl. 250/288

(57) ABSTRACT

An analyzer carrying out analysis with a high degree of qualitative accuracy by separating impurities which hinder the analysis while analyzing in real time. An introducing tube is branched with one branched tube directly leading to an ion source for real time analysis. The other branched tube leads to the ion source so as to introduce the sample gas into the ion source at a later time. When a result of the real time analysis shows that a spectrum pattern on a MS spectrum is changed and an increase in the concentration of an impurity is observed, the introducing path for the sample gas is changed so that the sample gas is introduced into the ion source after the impurity is separated at the separation part.

### CLAIM OF PRIORITY

The present application claims priority from Japanese application JP 2006-325130 filed on Dec. 1, 2006, the content of which is hereby incorporated by reference into this application.

### FIELD OF THE INVENTION

The present invention relates to an analyzer continuously analyzing a sample gas, and a method for analysis using the same.

### BACKGROUND OF THE INVENTION

Hereinafter, gas chromatograph, mass spectrometer, apparatus composed of gas chromatograph and mass spectrometer combined together, atmospheric pressure chemical ionization, chemical ionization, and electron impact are referred to as GC, MS, GC/MS, APCI, CI, and EI respectively.

JP-A No. 06 (1994)-310091 discloses a highly-sensitive analyzer continuously analyzing a sample gas by directly introducing the sample gas into an APCI ion source. Further, JP-A No. 2001-147216 discloses a method of comparing the analyzed result of two constituents by adding a standard substance having the approximately same ionization efficiency as that of a molecule to be measured as a quantitative analysis method of real-time measurement by directly introducing a sample gas into an APCI ion source.

JP-A No. 11 (1999)-295269 discloses a configuration of changing a system for directly introducing a sample gas to an atmospheric pressure ionization mass spectrometer to a system for introducing through a gas chromatograph to the atmospheric pressure ionization mass spectrometer by disposing a means for changing flow paths at a sample gas introducing tube.

JP-A No. 2006-86002 discloses a configuration of attaining high sensitivity by separating a sample gas in a GC column, and by providing a GC column outlet at an ion molecule reaction region of an APCI ion source.

### SUMMARY OF THE INVENTION

When a sample gas to be measured is continuously introduced in an analyzer, impurities in the sample gas often interfere with the analysis. JP-A No. 6 (1994)-310091 does not disclose any description regarding a concentration calibration method for when the sensitivity of the constituent to be measured varies due to the contamination of impurities when in continuous measurement.

In the method described in JP-A No. 2001-147216, an introducing system for adding a standard sample is complicated because of many constituents to be measured, or the addition of the standard sample itself cannot be applied in some cases on account of cost and the like. In case of adding no standard sample, the ionization efficiency of a constituent to be measured varies when the impurity concentration varies such that it is difficult to calibrate a concentration value from a signal intensity on a MS spectrum. Furthermore in general, when some change such as a process fluctuation occurs, the impurity concentration varies, which leads to a possibility of variations in the concentration of the constituent to be measured. However, in the prior art, it has been difficult to quantitatively analyze the constituent to be measured with good accuracy when the impurity concentration varies when adding no standard sample.

In the method described in JP-A No. 11 (1999)-295269, while a sample gas is directly introduced into an atmospheric pressure ionization mass spectrometric analyzer, a flow path is changed so as to introduce the sample gas into the analyzer through a gas chromatograph after detecting that the impurity concentration varies. In these circumstances, it is difficult to analyze because the sample gas to be measured at a time when the impurity concentration begins to vary is consumed/exhausted in a preceding analysis. Further, if a sample gas containing many impurities is continuously introduced into the gas chromatograph, a variety of impurities intricately overlap, which results in fluctuation in sensitivity and the like.

JP-A No. 2006-86002 does not disclose a method for continuously measuring constituents to be measured.

According to the present invention, an introducing tube for a sample gas is branched. One branched introducing tube is directed straight to an ion source for analyzing in real time. The other branched introducing tube is directed to the ion source in such a manner that the sample gas reaches the ion source at a later time. The other branched tube also has a separation part for separating impurities and thereafter introducing the sample gas into the ion source. When a result of the real time analysis shows that a spectrum pattern on a MS spectrum is changed and an increase in the concentration of a impurity is observed, the introducing path for the sample gas is changed so that the sample gas is introduced into the ion source after the impurity is separated at the separation part. With the above mentioned configuration, when the concentration of the impurity varies, an accurate quantitative analysis is possible without being affected by the impurity. Alternatively, with a configuration dispensing with the separation part, an accurate quantitative analysis is possible even when the concentration of a constituent is abruptly increased, by means of changing the introducing path for the sample gas having such a high concentration that exceeds a measurement range in the real time analysis, so as to introduce the same sample constituent into the ion source at a later time after the measurement range of the instrument is altered.

According to one aspect of the present invention, an introducing tube is branched to a flow path introducing a sample gas directly into an ion source, and to a flow path introducing the sample gas into an adsorbing tube having a solid adsorbent packed therein. A separation part is provided at a downstream portion of the adsorbing tube. The outlets of the two flow paths are connected to the same ion source or to another ion source. For an ordinary analysis, the sample gas introduced directly in the ion source is analyzed in real time. When an impurity can be observed on the spectrum so that the concentration thereof has been increased, the flow path is changed to introduce the constituent concentrated on the adsorbing tube into the same ion source or another ion source after separating from the impurity through the separation part for analysis. Thus, since the sample constituent is concentrated on the adsorbing tube at a time of increasing impurity, accurate analysis is possible by separating the impurity.

According to the present invention, it is possible to analyze with a high degree of accuracy even when the concentration of the impurity varies while analyzing in real time.

### BRIEF DESCRIPTION OF THE DRAWINGS

FIG. 1 is a schematic apparatus showing a configuration of an embodiment of the analyzer in accordance with the present invention;

FIG. 2 is a schematic diagram for observing a impurity concentration increase;

FIG. 3 shows a configuration example provided with a concentration part at an upstream of a separation part;

FIG. 4 is a sequence diagram of measurement;

FIG. 5 is a flowchart of measurement; and

FIG. 6 shows an embodiment of analysis changing APCI ionization to EI ionization.

### DETAILED DESCRIPTION OF THE PREFERRED EMBODIMENT

### First Embodiment

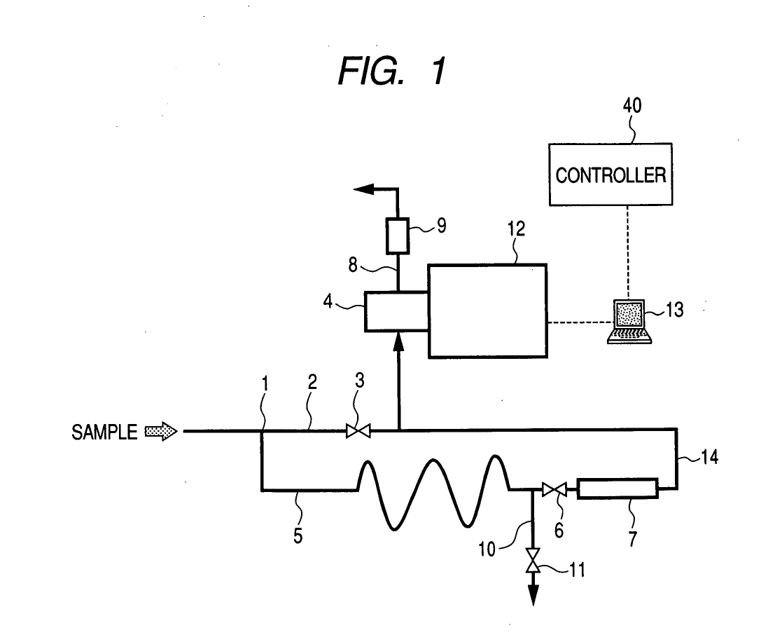

FIG. 1 is a schematic apparatus showing an embodiment of the instrument in accordance with the present invention. For ordinary continuous real time measurement, a sample gas is divided at a branch part 1, and one part of the sample gas is introduced through an introducing tube 2 and a valve 3 into an ion source 4 for real time analysis. The other part of the sample gas is introduced in an introducing tube 5, and exhausted through a valve 11 from an exhaust tube 10. The sample gas introduced into the ion source 4 is exhausted through a flow controller 9 from an exhaust tube 8. A valve 6 provided at the introducing tube 5 is closed when in real time analysis (when the valve 3 is open). A separation part is connected at the downstream of a valve 6, and is connected through a tube 14 to the ion source 4. The changing operation of the valves is controlled by a controller 40. As for an analysis part 12, an ion mobility analyzer and the like may be used in addition to mass spectrometers such as a quadruple mass spectrometer, an ion trap mass spectrometer, a time-of-flight mass spectrometer, and a Fourier transform mass spectrometer. A case using a mass spectrometer, for example, is explained hereinafter. As for the ion source 4, ionization methods such as APCI, EI, CI, and DART™ (Direct Analysis in Real Time) may be used.

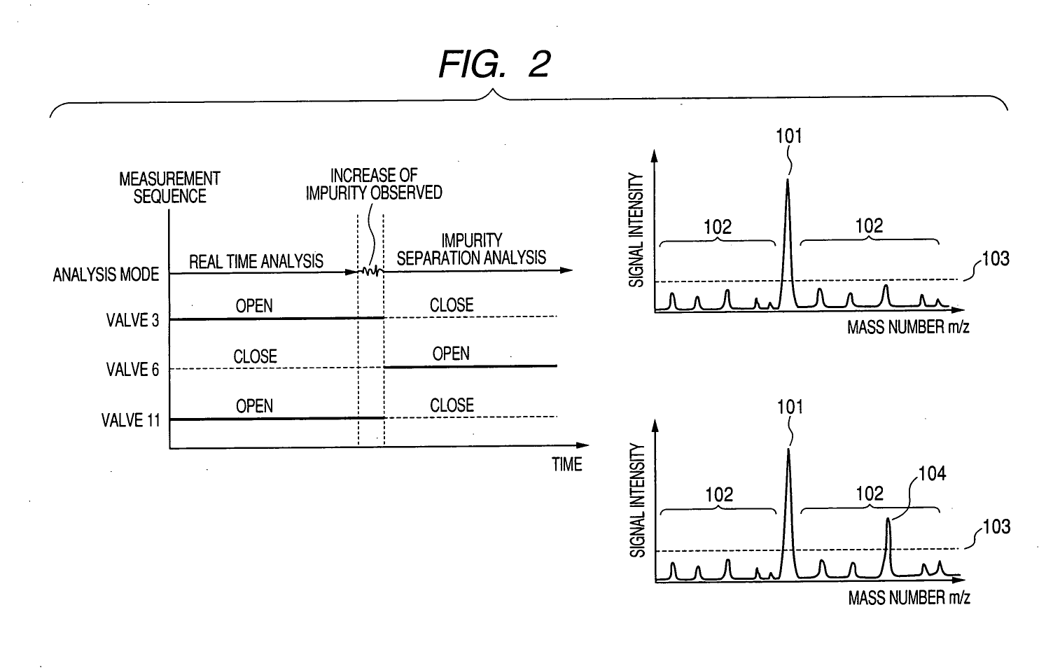

While a constituent to be measured is continuously measured in real time with the instrument mentioned above, observation is made at the same time whether signals of other impurities vary or not on the mass spectrum. When signals of impurities are greatly increased on the mass spectrum, an operating condition is changed so as to introduce the sample gas through the separation part 7 into the ion source. Whether the impurity is increased or not is decided as shown in FIG. 2. An ordinary value of the variation upper limit 103 (a threshold value) of signal intensity at mass numbers (m/z) of the impurities 102 other than the constituent to be measured 101 is stored in a database of a data processing computer 13. In this case, it is applicable to determine one variation upper limit (one threshold value) over the total range of mass numbers to be measured, or to determine a variation upper limit (a threshold value) at a mass number of a specific impurity higher than that at other mass numbers when the signal intensity value at the mass number of the specific impurity is known to be ordinarily high. During continuous measurement, if a peak that surpasses the upper limit is observed, it may indicate that the impurity 104 corresponding to the peak is increased. The controller 40 controls to close the valve 3 and the valve 11, and to open the valve 6 when the signal intensity at the mass number of the impurity 104 exceeds the upper limit 103 (the threshold value). The sample gas is introduced into the separation part 7 through the introducing tube 5 and the valve 6. The impurity is separated at the separation part 7 and the sample gas is led into the ion source 4 through the tube 14. If there is such a difference of the boiling points between the impurity having a boiling point of 200° C. and the constituent to be measured having a boiling point of 60° C., for example, the separation part where an adsorbent (such as TENAX™) is packed in a glass tube is kept at approximately 120° C., and then the impurity having a higher boiling point is adsorbed and the constituent to be measured having a lower boiling point is passed without adsorption and introduced through the tube 14 into the ion source. In this case, as the length between the branch part and the ion source of the introducing tube 5 is greater than that of the introducing tube 2, the constituent to be measured is introduced later through the tube 14 when the concentration of the impurity is increased in real time analysis so that the constituent to be measured separated from the impurity can be analyzed with a high degree of precision.

### Second Embodiment

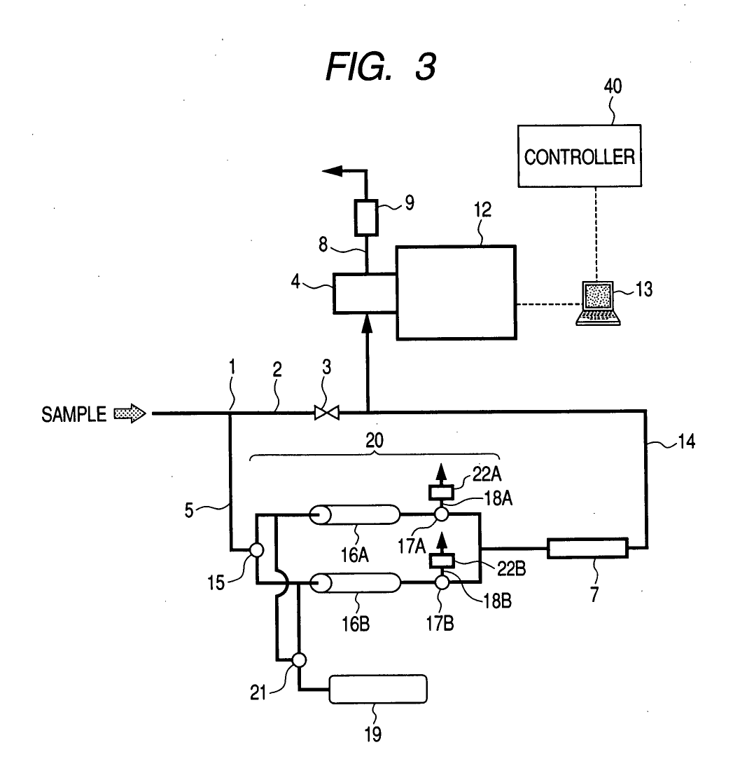

FIG. 3 is a block diagram showing a configuration example provided with a concentration part 20 at an upstream of a separation part 7 of an introducing tube 5. As explained in FIG. 1, ordinarily a sample gas is introduced through an introducing tube 2 and a valve 3 into an ion source 4 for real time analysis. At the same time, a part of the sample gas is introduced through the introducing tube 5 into the concentration part 20. The concentration part 20 comprises a plurality of concentration tubes. (In FIG. 3, a case of two concentration tubes is explained.) However, one concentration tube is applicable depending on a sample gas. The sample gas is led to the concentration tube 16A through a change valve 15. The concentration tube 16A contains a material adsorbing or absorbing chemically or physically the constituents. A material having a function of adsorbing on a solid surface is exemplified as follows. The concentration tube 16A is maintained at a temperature low enough to adsorb the constituent to be measured so that the constituent is adsorbed. An inert gas passing through the concentration tube 16A without having been adsorbed are exhausted from an exhaust tube 18a through a change valve 17A. A sample gas flow rate at which the sample gas is introduced into the concentration tube is preferably controlled with a flow controller 22A/B disposed at the exhaust tubes 18A/B. During this time, the other concentration tube 16B is heated to regenerate by desorbing the constituent adsorbed before. A carrier gas is introduced from a carrier gas cylinder 19 through a change valve 21 at the upstream of the concentration tube 16B and the constituent desorbed is exhausted from the exhaust tube 18B through the change valve 17B. An inert gas such as helium and nitrogen is preferable for use as a carrier gas.

When the impurity concentration is not varied in real time analysis, the adsorption and the regeneration at the concentration tube 16A and 16B of the concentration part 20 are alternately changed at an appropriate time interval. In other words, when the concentration tube 16A is changed to regeneration, the change valve 15 and the change valve 21 are changed so as to introduce the sample gas into the concentration tube 16B and the carrier gas into the concentration tube 16A. Further, the constituent that was adsorbed is desorbed by heating the concentration tube 16A to exhaust through the change valve 17A from the exhaust tube 18A. Simultaneously, the constituent in the sample gas is adsorbed by cooling the concentration tube 16b.

When the impurity concentration is observed to be increased in real time analysis, the constituent that was adsorbed is desorbed to be introduced into the ion source 4 by controlling with the controller 40. For example, if the impurity concentration is increased during adsorption at the concentration tube 16A, the concentration tube 16A is heated and the constituent is desorbed from the concentration tube 16A by introducing the carrier gas from the change valve 21 and is introduced into the separation part 7 by changing the change valve 17A. As a result, the constituent is not exhausted from the exhaust tube 18A, and further, the valve 3 is closed. The separation part 7 separates the impurity from the constituent to be measured, which results in an analysis with high quantitative precision. A separation method by a GC can be used for a separation part 7 in addition to utilization of the above boiling point difference.

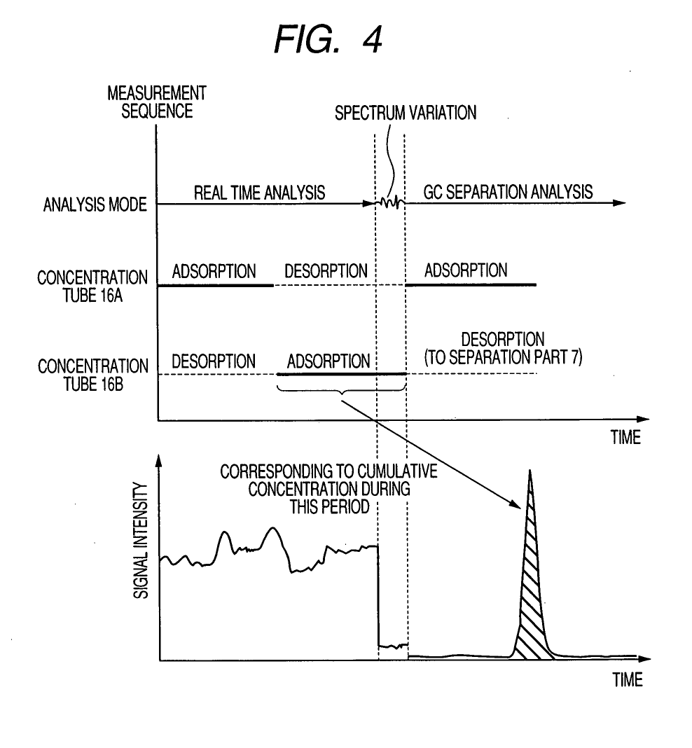

FIG. 4 is a sequence diagram of the measurement obtained by a configuration using a GC for a separation part 7 shown in FIG. 3. During real time analysis, adsorption and desorption are alternately repeated with the concentration tubes 16A and 16B. When the impurity concentration is observed to be increased in real time analysis, the constituent adsorbed in the concentration tube during the adsorption process (the concentration tube 16B shown in FIG. 4 for example) is desorbed to be introduced into the separation part 7 (the GC) without being exhausted from the exhaust tube 18B by controlling with the controller. The constituent to be measured is separated from the impurity in the GC and introduced into the ion source. During desorption, the other concentration tube is preferably subjected to the desorption process for the next measurement. A signal generated by the constituent desorbed and introduced into the ion source is converted to a peak of a gas chromatogram shown in FIG. 4. A cumulative concentration during adsorption at the concentration tube (16B) is obtained from an area of the peak. After the measurement, the process may be returned to a mode for real time measurement, or a measurement of desorbing the constituent adsorbed and similarly separating it by the GC may be carried out. Though FIG. 3 shows an embodiment of two concentration parts, it is possible to return to real time analysis after desorbing the constituent adsorbed in one concentration part and analyzing it.

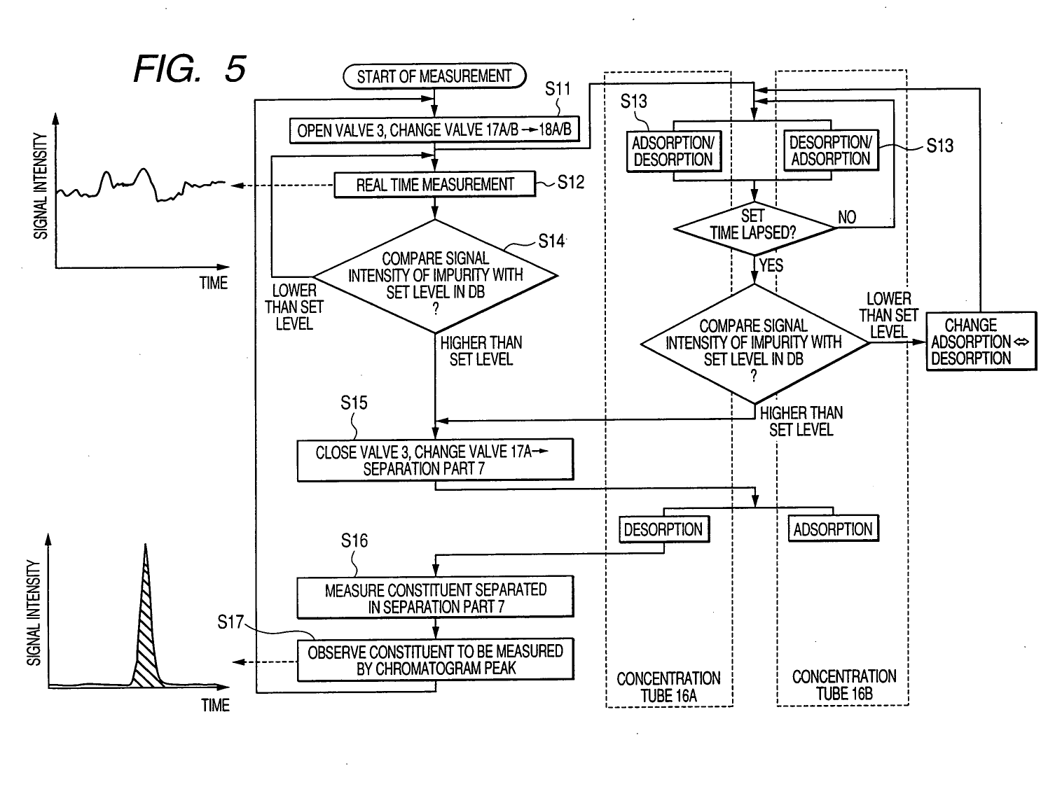

FIG. 5 is a flowchart of the measurement by the configuration shown in FIG. 3 using the GC as the separation part 7. First, the valve 3 is opened and the change valves 17A and 17B are changed so that gas flows to the exhaust tubes 18A and 18B (S11). Real time measurement is carried out by introducing the sample gas into the ion source through the branch part 1 and the introducing tube 2 (S12). The concentration tubes 16A and 16B are changed alternately for adsorption and desorption (S13). A signal intensity of the impurity measured on the mass spectrum in real time is compared with the signal level (the threshold value) precedently set in the data base (S14). If the signal intensity of the impurity is lower than the set level (the threshold value), the real time measurement is continued. If a signal intensity of the impurity exceeds the set level (the threshold value) at a certain time, then the valve 3 is opened and the change valve 17A (in case the concentration tube 16A is in an adsorption process when surpassing the level shown in FIG. 5) is changed so as to introduce the constituent desorbed into the separation part 7 (the GC) (S15). After analyzing the constituent to be measured as the peak of the chromatogram (S16, S17), measurement is continued by returning to real-time analysis.

### Third Embodiment

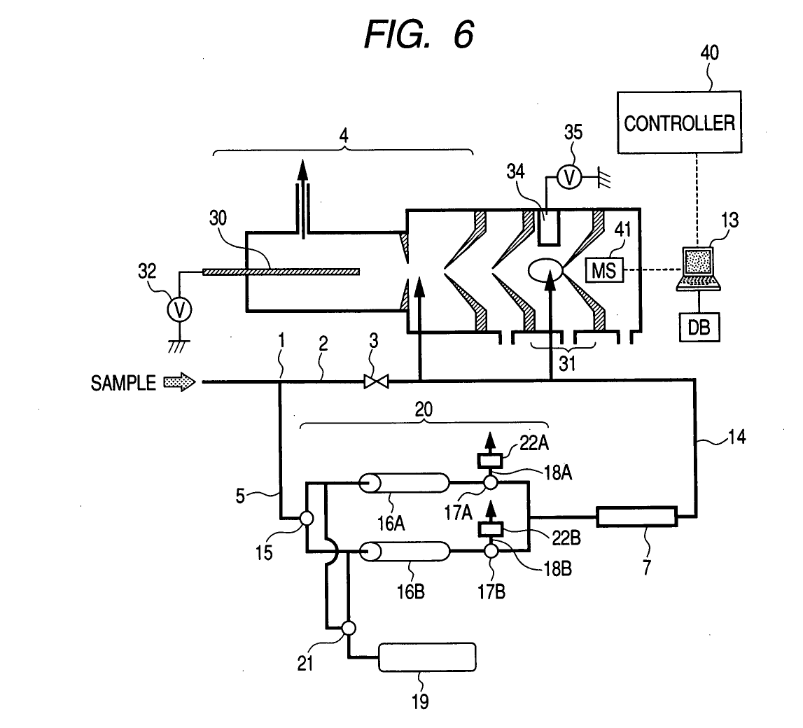

In the above explanation, the ion source using for real time measurement is the same ion source as using for measuring by separating the impurity. The ion sources using other ionization methods may be used for measurement as shown in FIG. 6. In the embodiment shown in FIG. 6, an atmospheric pressure chemical ion source using a needle electrode 30 is used for real time measurement as an ion source 4; and an EI ion source is used for separating and measuring the impurity as an ion source 31. EI ionization gives information for identifying an ion by a fragment pattern generated. For an ordinary measurement, measurement is carried out by atmospheric pressure chemical ionization. When an impurity increases, the impurity is separated so as to analyze the constituent to be measured with high precision, and, at the same time, qualitative information about the increased impurity is obtained. As shown in FIG. 6, when in real time measurement, a signal for activating a power source 32 to be applied on the needle electrode 30 is communicated from a controller 40 and a signal for deactivating a power source 35 for a filament 34 for EI ionization is communicated from the controller 40. When a sample gas is introduced into the EI ion source 31 through the separation part 7 in case of an increased impurity concentration, a signal for deactivating the power source 32 to be applied on the needle electrode 30 is communicated from the controller 40 and a signal for activating a power source 35 for a filament 34 for EI ionization is communicated from the controller 40. Other ionization methods may be used such as a CI ion source in addition to the EI ion source shown in FIG. 6.

Alternatively, two atmospheric pressure chemical ion sources of negative ionization and positive ionization can be alternately changed in the embodiment shown in FIG. 3. In case a constituent to be measured has high sensitivity but is influenced by impurities with positive ionization and the constituent to be measured has low sensitivity but is not influenced by impurities with positive ionization, the real time measurement is carried out with negative ionization. When the concentration of the constituent to be measured is decreased to near a defection limit, the ionization polarity can be changed to the positive ionization to separate the impurity.

Such an analyzer carrying out real time analysis and impurity separation analysis can be applied to the measurement of an exhaust gas from a chemical plant in order to detect abnormal conditions in a process for removing environmental hazardous substances. If the concentration of an impurity (an inorganic substance such as hydrogen chloride, hydrogen sulfide or a hydrocarbon), which influences the measurement, increases while monitoring a concentration variation of an object to be measured of an environmental hazardous substance (e.g. a dioxin), an operator of the process can be warned about any abnormalities in the process which should otherwise work correctly under normal conditions.

The present invention can provide an analyzer and a method for analysis since it has two measurement techniques of real time analysis and of an analysis that separates a impurity when the quantitative analysis accuracy is lowered due to the impurity.

What is claimed is:

1. An analyzer comprising:
a first introducing tube for introducing a sample gas into an ion source; and
a second introducing tube branched from the first introducing tube at a branched part,
wherein the second introducing tube is formed to selectively introduce the sample gas into the ion source later than the sample gas from the first introducing tube.

2. The analyzer according to claim 1, wherein the length from the branch part to the ion source of the second introducing tube is longer than that of the first introducing tube.

3. The analyzer according to claim 1, further comprising: a control part for changing a flow of the sample gas into the ion source; the control part being configured to change the flow from the first introducing tube to the second introducing tube when a signal intensity of a constituent in the sample gas other than a constituent to be measured exceeds a threshold value.

4. The analyzer according to claim 1, wherein a separation part for separating the sample gas is arranged in the second introducing tube.

5. The analyzer according to claim 1, wherein a concentration part for concentrating the sample gas is arranged between the branch part and the ion source in the second introducing tube.

6. The analyzer according to claim 3, wherein a separation part for separating the sample gas is arranged in the second introducing tube.

7. The analyzer according to claim 6, wherein a concentration part for concentrating the sample gas is arranged between the branch part and the separation part.

8. The analyzer according to claim 1, wherein the ion source is one of an atmospheric pressure chemical ionization means, an electron impact ionization means, and a chemical ionization means.

9. The analyzer according to claim 4, wherein the separation part is a gas chromatograph.

10. The analyzer according to claim 1, further comprising an analysis part into which the sample gas ionized in the ion source is introduced, wherein the analysis part is one of a quadruple mass spectrometer, an ion trap mass spectrometer, a time-of-flight mass spectrometer, a Fourier transform mass spectrometer, and an ion mobility analyzer.

11. The analyzer according to claim 5, wherein the concentration part has a first concentration part and second concentration part arranged of branched tubes of the second introducing tube, and the timings of adsorption and desorption of the sample are alternate in the first and second concentration part.

12. The analyzer according to claim 1, wherein the ion source is comprised of a first ion source and a second ion source, and the sample gas is introduced into the first ion source through the first introducing tube and the sample gas is introduced into the second ion source through the second introducing tube.

13. The analyzer according to claim 12, wherein one of the first ion source and the second ion source is a negative ionization source and the other is a positive ionization source.

14. A method for analysis using an ion source, an analysis part analyzing ions from the ion source, a first introducing tube for introducing a sample gas into the ion source, and a second introducing tube branched from the first introducing tube for introducing the sample gas into the ion source, comprising steps of:
introducing the sample to the ion source through the first introducing tube;
measuring signal intensities of the introduced sample gas through the first introducing tube at the analysis part,
comparing a signal intensity of a constituent other than a constituent to be measured with a threshold value;
changing the flow of the sample gas into the ion source from the first introducing tube to the second introducing tube when the signal intensity of the constituent other than the constituent to be measured exceeds the threshold value; and
obtaining a signal of the sample gas introduced into the ion source through the second introducing tube.

15. The method for analysis according to claim 14, further comprising the step of separating the sample gas at a separation part arranged in the second introducing tube.

16. The method for analysis according to claim 14, wherein the second introducing tube has a first and a second concentration parts arranged of branched tubes of the second introducing tube, further comprising the steps of:
controlling the timings of adsorption and desorption of the sample gas to alternate in the first and second concentration parts;
introducing one of constituents desorpted at the concentration part into a separation part arranged between the concentration part and the ion source when its intensity exceeds the threshold value; and
obtaining a signal of the constituent at the analysis part.

17. The method for analysis according to claim 12, the ion source is comprised of a first ion source and a second ion source, and the sample gas is introduced into the first ion source through the first introducing tube and the sample gas is introduced into the second ion source through the second introducing tube.
